(19) United States
(12) Patent Application Publication
(10) Pub. No.: US 2006/0200349 A1
(43) Pub. Date: Sep. 7, 2006

(54) Electronic device of an electronic voice dictionary and method for looking up a word and playing back a voice

(75) Inventors: David Ho, Taipei (TW); Wen-Ming Wang, Shanghai City (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/168,301

(22) Filed: Jun. 29, 2005

(30) Foreign Application Priority Data
Mar. 4, 2005 (TW) 094106595

(51) Int. Cl. G10L 15/04

(52) U.S. Cl. 704/251

(57) ABSTRACT

An electronic device of an electronic voice dictionary and a method for looking up a word and playing back a pronouncing voice include a key code table in a memory for storing key code values and letters corresponding to key code values, a storage unit containing data signals and voice signals corresponding to each data signal. The data signal and the voice signal correspond to a word or phrase, so that when a keyboard enters into an input signal, a microprocessor searches for the key code table and an audio processing unit searches for the data signal and the voice signal corresponding to a word or a phrase and decodes the voice signal, which is then sent to a voice output section for the playback.

### FIELD OF THE INVENTION

The present invention generally relates to an electronic voice dictionary, and more particularly to an electronic device of an electronic voice dictionary and a method for looking up a word and playing back a voice.

### BACKGROUND OF THE INVENTION

The blooming wireless communication technology has a significant impact to the present society, particularly in the mobile phone area. The rapid growth greatly expands the market scale and also drives the mobile phone industry forward and innovative. The number of present mobile phone users exceeds 1 billion, and the functions of mobile phone are not limited to communications only. In the severe competition of the present market, mobile phone manufacturers provide various different functions and services to expand their market share of mobile phones. Different kinds of powerful functions and all-purpose services are provided to meet the future development trend of mobile phones.

Since the transportation means and information flow are well developed, more and more global entities in the areas of business, traveling, enterprises, academics and other fields are emerged under the trend of globalization and internationalization. Therefore, individuals, multinational corporations or academic organizations are facing a need of using foreign languages for different occasions. However, a vast majority of people is not proficient in foreign languages, and thus it is not easy for them to communicate fluently with foreigners. Thus, language tools such as dictionaries, translating machines and computer software are needed in our daily life and work.

Prior art translation tools generally install translation software into a personal computer, so that when a personal computer user is using the personal computer, the user starts the translation software to look up or translate a word. However, the application of this sort is restricted to a fixed place, and thus some manufacturers develop a translating machine which has the functions of looking up or translating a word anywhere. Such translating machine is portable, and a user can conveniently use it anytime and anywhere. Compared with the traditional foreign language dictionary, the translating machine is a great improvement. Further, as electronic information technology is advancing, another kind of translating tool installs translation software in a personal digital assistant (PDA), so that a PDA user can look up or translate a word by the translation software while using other functions of the PDA. This kind of translating machine is more advanced than the previous kind.

However, the translating machine and the PDA are portable and can be used anytime and anywhere. Compared with the popularity and necessity of mobile phones, the translating machine and PDA are not necessities of our daily life. People have to spend extra money to buy them. If users do not carry the translating machine and the PDA with them, they cannot look up or translate a word handy. If we can use the present advanced telecommunication technology to install software and hardware in a mobile phone for looking up or translating a word, so that we can use the mobile phone for the translation, then it will save lots of costs and eliminate the trouble of carrying the translating machine and PDA.

### SUMMARY OF THE INVENTION

In view of the foregoing shortcomings of the prior art, the inventor of the present invention based on years of experience to conduct extensive researches and experiments and finally invented an electronic device of an electronic voice dictionary and a method for looking up a word and playing back its voice, in hope of contributing the present invention to the general public.

Therefore, it is a primary objective of the present invention to provide an electronic device of an electronic voice dictionary, which comprises a keyboard for inputting an input signal, and the input signal can be sent to a microprocessor; the microprocessor can search for a key code table stored in a memory according to the input signal for searching for a key code value corresponding to the input signal, and a letter of an alphabet corresponding to the key code value is sent to an audio processing unit for completing the input of a word or a phrase. The audio processing unit searches for a plurality of data signals and a plurality of voice signals stored in a storage unit according to the inputted letter. The data signal corresponding to a letter is sent to the microprocessor, and the microprocessor sends the data signal to a screen. The audio processing unit decodes the voice signal corresponding to the data signal and sends the voice signal to a voice output section, so that after a user completes inputting a word or a phrase, the screen can display the data corresponding to the inputted word or phrase, and the voice output section can play back a voice corresponding to the inputted word or phrase. The electronic device can achieve the function of timely looking up a word or a phrase and playing back a voice.

Another objective of the present invention is to provide a method of looking up a word by an electronic device and playing back a voice, and the electronic device comprises a keyboard, a microprocessor, a memory, an audio processing unit, a storage unit, a screen and a voice output section. The memory has a key code table, and the key code table stores a plurality of key code values and a plurality of letters of an alphabet, and each key code value corresponds to a letter. The storage unit contains a plurality of data signals and a plurality of voice signals, and each data signal corresponds to a voice signal. The data signal and the voice signal correspond to a word or phrase, so that the keyboard enters an input signal, the microprocessor searches, according to at least one key code value in the input signal, for the key code table so as to complete the input of a word or a phrase and initialize the audio processing unit. The audio processing unit searches for the data signal and the voice signal corresponding to a word or a phrase in the storage unit, and the microprocessor sends the data signal to the screen, so that the data signal is displayed on the screen. Further, the audio processing unit decodes the voice signal according to a voice signal inputted from the keyboard and sent from the microprocessor. The decoded voice signal is sent to the voice output section for the playback, and then the word or phrase can be looked up and the voice can be played back.

The above and other objects, features and advantages of the present invention will become apparent from the following detailed description taken with the accompanying drawings.

### BRIEF DESCRIPTION OF THE DRAWINGS

FIG. 1 is a schematic view of the structure of an electronic device of the present invention;

FIG. 2 is a schematic view of connecting the microprocessor and the audio processing unit of an electronic device of the present invention;

FIG. 3 is a schematic view of another preferred embodiment of the present invention;

FIG. 4 is a flow chart of starting the function of an electronic voice dictionary of the present invention;

FIG. 5 is a flow chart of playing back a voice according to the present invention;

FIG. 6 is a schematic view of initialize the audio processing unit and switching modes according to the present invention; and

FIG. 7 is a flow chart of playing back a voice according to the present invention.

### DETAILED DESCRIPTION OF THE PREFERRED EMBODIMENTS

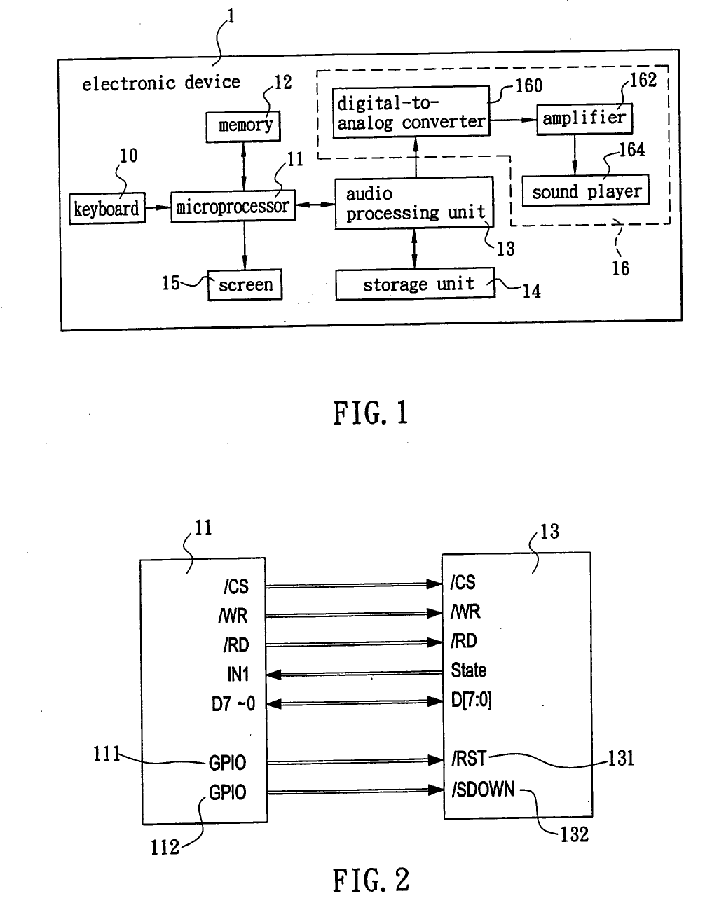

Referring to FIG. 1, an electronic device of an electronic voice dictionary and a method for looking up a word and playing back a voice in accordance with the present invention are illustrated. The electronic device comprises a keyboard 10, a microprocessor 11, a memory 12, an audio processing unit 13, a storage unit 14, a screen 15, a voice output section 16; wherein the microprocessor 11 receives an input signal inputted by the keyboard 10 and searches, according to the input signal, for a key code table stored in the memory 12, so as to search for a key code value corresponding to the input signal in the key code table. A letter of an alphabet corresponding to the key code value is sent to the audio processing unit 13 to complete the input of a word or a phrase. The audio processing unit 13 searches for a plurality of data signals and a plurality of voice signals according to the inputted letters. The data signals corresponding to the letters are sent to the microprocessor 11, and the microprocessor 11 sends the data signals to the screen 15 to display the data signals. The voice processing unit 13 decodes the voice signals corresponding to the data signals, and the decoded voice signals are sent to the voice output section 16 for the playback, so that after a user inputs the input signal, the screen 15 displays the data corresponding to the inputted word or phrase. The audio output section 16 plays back the voice corresponding to the inputted word or phrase, so that the electronic device 1 can achieve the functions of timely looking up a word or a phrase and playing back a voice.

Referring to FIG. 1 again for a preferred embodiment of the present invention, the voice output section 16 comprises a digital-to-analog converter 160, an amplifier 162 and a sound player 164; wherein the digital-to-analog converter 160 receives a decoded voice signal sent from the audio processing unit 13 and converts the decoded voice signal into an analog signal and sends the analog signal to the amplifier 162. The analog signal is modulated according to the gain of the amplifier 162 and played back by the sound player 164.

Referring to FIG. 2 for this embodiment, the microprocessor 11 comprises a first universal transmission pin 111 and a second universal transmission pin 112; wherein the first universal transmission pin 111 is connected to a reset signal input pin 131 of the audio processing unit 13, and the microprocessor 11 inputs a reset signal through the first universal transmission pin 111 to initialize the audio processing unit 13, and the second universal transmission pin 112 is connected to an on/off input signal pin 132 of the audio processing unit 13, and the microprocessor 11 inputs an on/off signal (such as a low potential) to the audio processing unit 13 through the second universal transmission pin 112 to enter the audio processing unit 13 into an off status or the on/off signal (such as a high potential) is inputted again to enter the audio processing unit into a general operating mode.

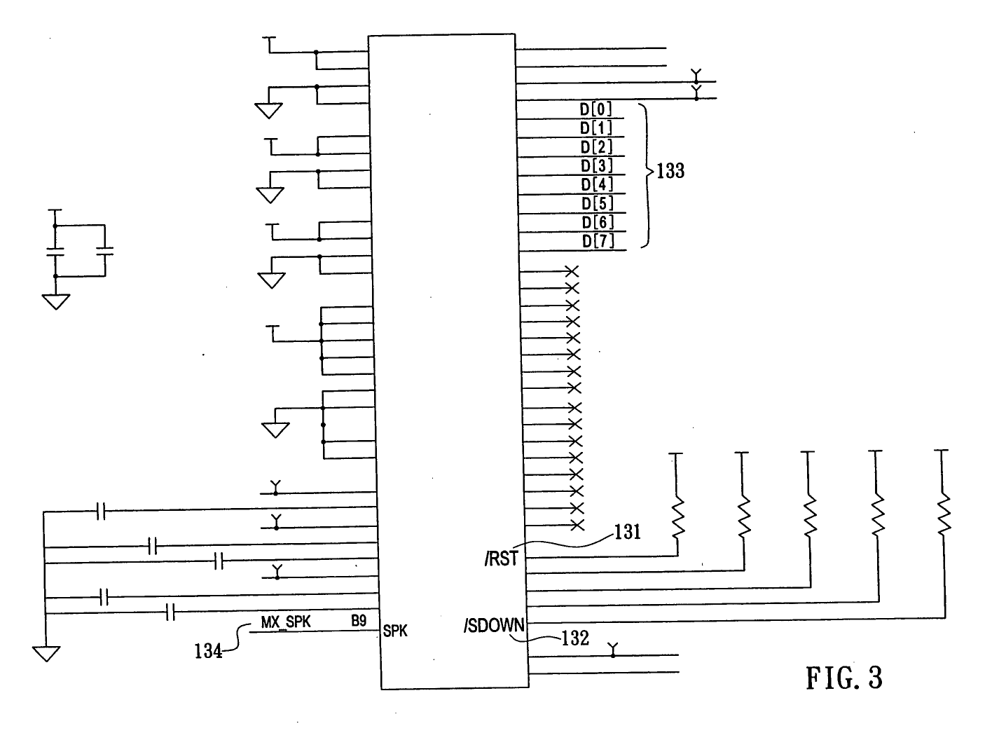

Referring to FIG. 3 for another preferred embodiment of the present invention, the audio processing unit 13 is a chip with a model number MX93L550, and the digital-to-analog converter 160, storage unit 14 and amplifier 162 are built in the chip. The audio processing unit 13 includes a reset signal input pin 131, an on/off signal input pin 132, a plurality of data signal output pins 133, and a voice signal output pin 134; wherein the reset signal input pin 131 receives a reset signal from the microprocessor 11, and the on/off signal input pin 132 receives an on/off signal from the microprocessor 11, and the data signal output pin 133 outputs the data signal in the storage unit 14 to the microprocessor 11, and the voice signal output pin 134 outputs the analog signal to the sound player 164, such that after the microprocessor 11 sends the letters to the audio processing unit 13 to complete the input of a word or a phrase, the audio processing unit 13 built in the storage unit 14 can search for the data signal and voice signal corresponding to the letters. The searched data signal is sent to the microprocessor 11 through the data signal output pin 133. The microprocessor 11 sends the data signal and displays the data signal on the screen 15. The audio processing unit 13 decodes the voice signal, and the built-in digital-to-analog converter 160 converts the decoded voice signal into an analog signal, and the gain of the built-in amplifier 162 modulates the analog signal. The analog signal is outputted to the sound player 164 for a playback, and it thus can greatly reduce the area of the printed circuit board for installing the required components.

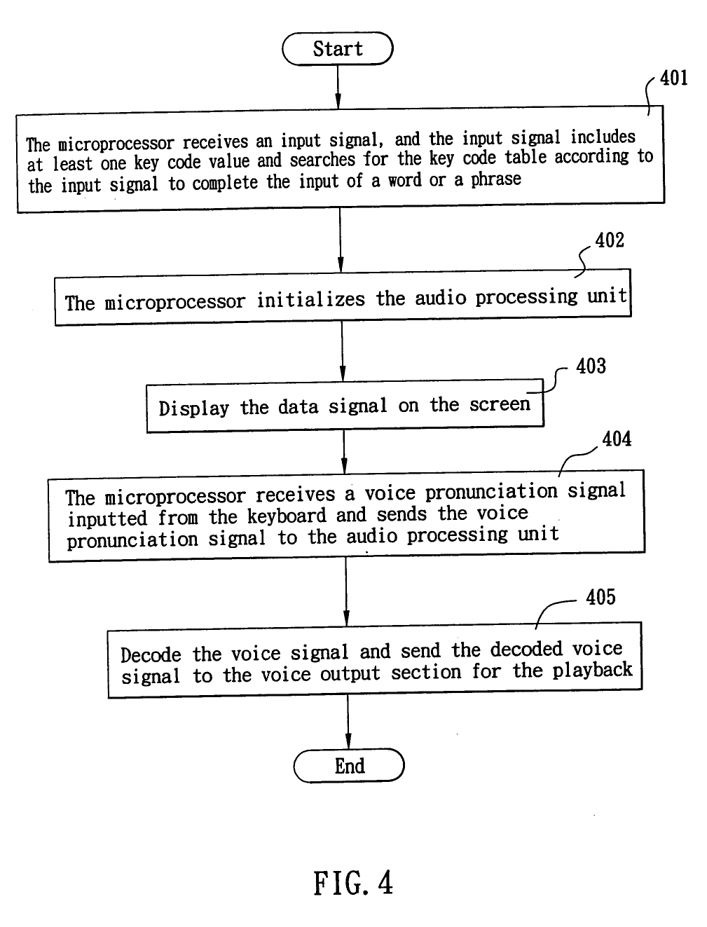

Referring to FIGS. 1 and 4 for the electronic device for looking up a word and method for playing back a voice in accordance of the present invention, the electronic device 1 comprises a keyboard 10, a microprocessor 11, a memory 12, an audio processing unit 13, a storage unit 14, a screen 15 and a voice output section 16. The memory 12 has a key code table, and the key code table stores a plurality of key code values and a plurality of letters. Each key code value corresponds to a letter, and the storage unit 14 has a plurality of data signals and a plurality of voice signals. Each data signal corresponds to a voice signal, and the data signal and voice signal correspond to a word or a phrase, so that the keyboard 10 can input and look up a word or a phrase. The microprocessor 11 proceeds according to the following procedure:

(401) The microprocessor 11 receives an input signal from the keyboard 10, and the input signal includes at least one key code value. The input signal is used to search for the key code table to complete the input of a word or a phrase;

(402) Initialize the audio processing unit 13;

(403) The audio processing unit 13 searches for the data signal and voice signal corresponding to a word or a phrase in the storage unit 14, and the data signal is sent to the screen 15 by the microprocessor 11, so that the data signal is displayed on the screen;

(404) The microprocessor 11 receives a voice pronunciation signal inputted from the keyboard 10, and the voice pronunciation signal is sent to the audio processing unit 13; and

(405) The audio processing unit 13 decodes the voice signal according to the voice pronunciation signal, and the decoded voice signal is sent to the voice output section 16 for the playback.

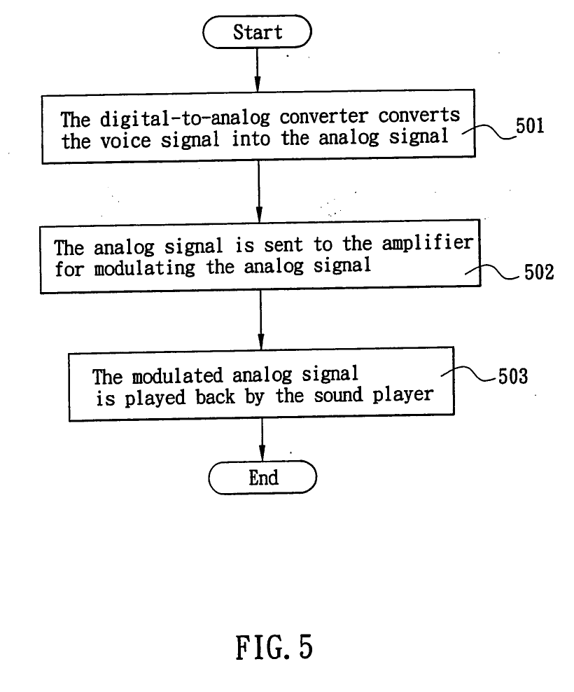

Referring to FIGS. 1 and 5 for the present invention, the voice output section 16 installs a digital-to-analog converter 160, an amplifier 162 and a sound player 164, such that after the voice signal is decoded, the following procedure proceeds:

(501) The digital-to-analog converter 160 converts the voice signal into an analog signal;

(502) The digital-to-analog converter 160 sends the analog signal to the amplifier 162. When the microprocessor 11 receives a modulate signal inputted from the keyboard 10, then the modulate signal will modulate the gain of the amplifier 162 to modulate the analog signal; and

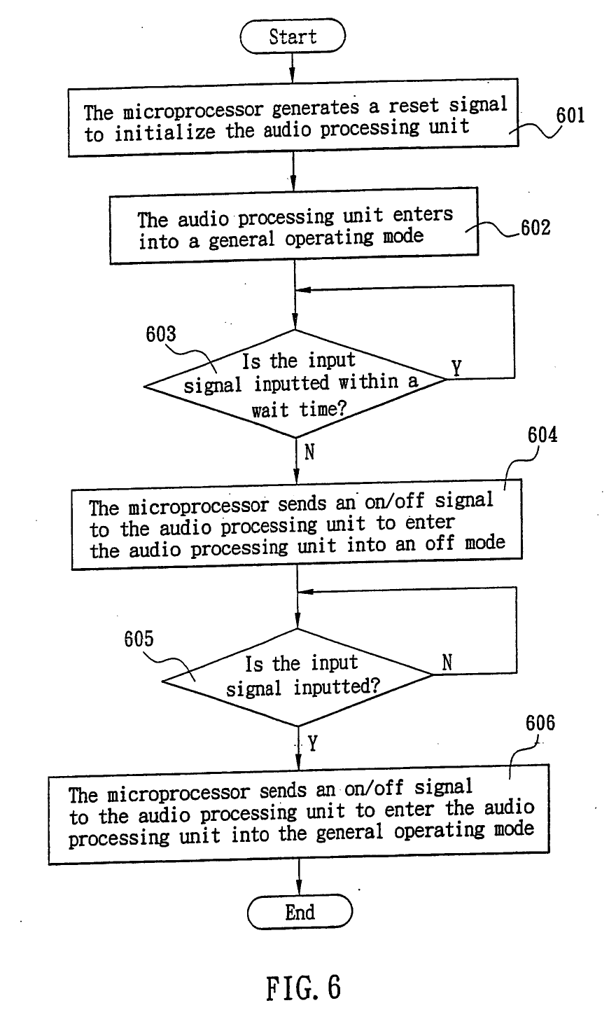

(503) The modulated analog signal is played back from the sound player 164. Referring to FIGS. 1 and 6 for the present invention, the electronic device 1 processes the following procedure to control the audio processing unit 13 after receiving the input signal:

(601) The microprocessor 11 generates a reset signal and sends the reset signal to the audio processing unit 13 to initialize the audio processing unit 13;

(602) The audio processing unit 13 enters into a general operating mode, and a word or a phrase sent from the microprocessor 11 is received under the general operating mode, and the corresponding data signal and voice signal in the storage unit 14 can be searched, so that a user can look up or translate a word;

(603) Determine whether or not the input signal is entered to the electronic device 1 within a wait time; if no, go to Step (604), or else go to Step (603);

(604) The microprocessor 11 sends an on/off signal to the audio processing unit 13, so that the audio processing unit 13 enters into an off mode;

(605) Determine whether or not the input signal is entered to the electronic device 1; if yes, go to Step (606), or else got to Step (605); and

(606) The microprocessor 11 sends the on/off signal to the audio processing unit 13, so that the audio processing unit 13 enters. into a general operating mode, and a user can look up or translate a word.

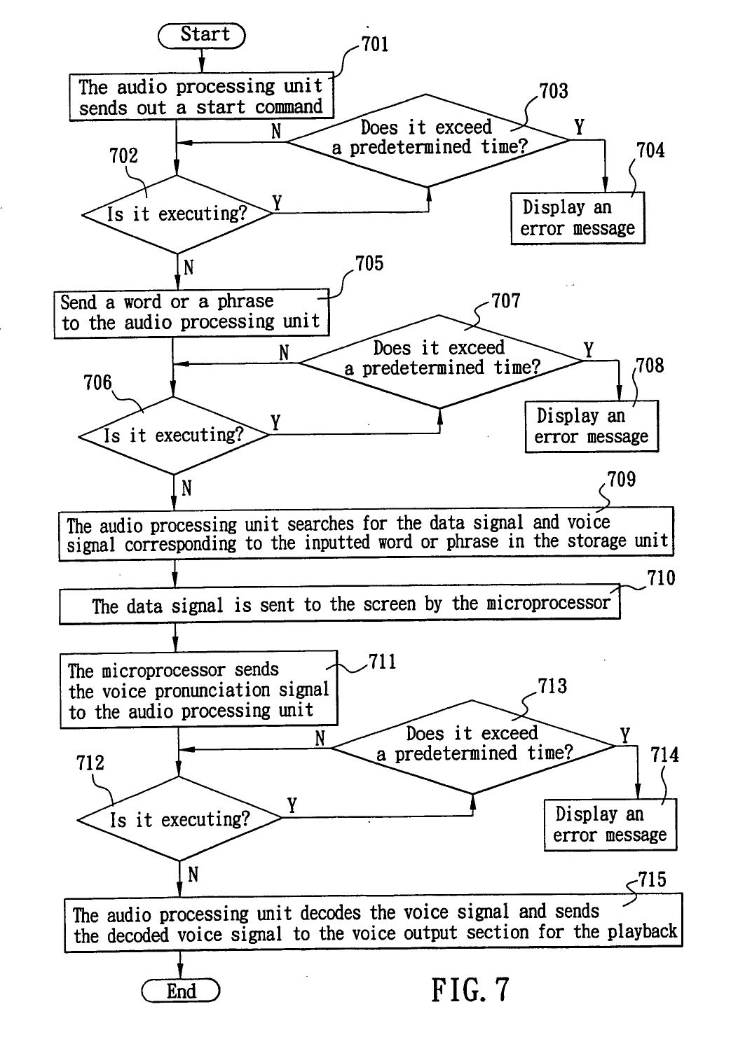

Referring to FIGS. 1 and 7 for the present invention, the microprocessor 11 processes the following procedure after the key code table is searched according to the input signal:

(701) The audio processing unit 13 sends out a start command;

(702) Determine whether or not the audio processing unit 13 is executing; if yes, go to Step (703), or else go to Step (705);

(703) Determine whether or not the execution of the audio processing unit 13 exceeds a predetermined time; if yes, go to Step (704), or else go back to Step (702);

(704) Display an error message;

(705) Send a word or a phrase to the audio processing unit 13;

(706) Determine whether or not the audio processing unit 13 is executing; if yes, go to Step (707), or else go to Step (709);

(707) Determine whether or not the execution of the audio processing unit 13 exceeds a predetermined time; if yes, go to Step (708), or else go back to Step (706);

(708) Display an error message;

(709) The audio processing unit 13 searches for the data signal and voice signal corresponding to a word or a phrase in the storage unit 14 according to the inputted word or phrase;

(710) Send the data signal to the screen 15 by the microprocessor 11;

(711) The microprocessor 11 sends a voice pronunciation signal to the audio processing unit 13;

(712) Determine whether or not the audio processing unit 13 is executing; if no, go to Step (715), or else go to Step (713);

(713) Determine whether or not the execution of the audio processing unit 13 exceeds a predetermined time; if yes, go to Step (714), or else go back to Step (712);

(714) Display the error message; and

(715) The audio processing unit 13 decodes the voice signal, and sends the decoded voice signal to the voice output section 16 for the playback.

While the invention has been described by means of specific embodiments, numerous modifications and variations could be made thereto by those skilled in the art without departing from the scope and spirit of the invention set forth in the following claims.

What is claimed is:

1. An electronic device of electronic voice dictionary, comprising:
a keyboard, for inputting an input signal;
a memory, for storing a key code table, and said key code table storing a plurality of key code values and a plurality of letters of an alphabet, and said each key code value corresponding to said each letter;
a storage unit, for storing a plurality of data signals and a plurality of voice signals, and said each data signal corresponding to said each voice signal;
a screen, for displaying said data signals;
a microprocessor, for receiving said input signal, and searching, according to said input signal, for said key code value corresponding to said input signal in said key code table, and sending out a letter corresponding to said key code value to complete an input of a word or a phrase, and receiving said each data signal and sending said each data signal to said screen;
an audio processing unit, for searching for a corresponding data signal and voice signal in said storage unit according to said letter inputted by said microprocessor, and sending said corresponding data signal to said microprocessor, and decoding and sending out said corresponding voice signal; and
a voice output section, for receiving said corresponding voice signal transmitted from said audio processing unit, and playing said corresponding voice signal after said corresponding voice signal being processed.

2. The electronic device of claim 1, wherein said voice output section comprises:
a digital-to-analog converter, for receiving said decoded voice signal transmitted from said audio processing unit and converting said voice signal into an analog signal;
an amplifier, for receiving said analog signal generated by said digital-to-analog converter and modulating said analog signal according to a gain of said amplifier; and
a sound player, for receiving said modulated analog signal from said amplifier for a playback.

3. The electronic device of claim 1, wherein said microprocessor comprises:
a first universal transmission pin, coupled with a reset signal input pin of said audio processing unit, and said microprocessor inputs a reset signal to said audio processing unit through said first universal transmission pin to initialize said audio processing unit;
a second universal transmission pin, coupled to an on/off signal input pin of said audio processing unit, and said microprocessor inputs an on/off signal to said audio processing unit through said second universal transmission pin to switch said audio processing unit to a general operating mode or an off status.

4. A method for looking up a word and playing back a voice for an electronic device, which comprises a keyboard, a microprocessor, a memory, an audio processing unit, a storage unit, a screen and a voice output section;
wherein said memory includes a key code table, said key code table stores a plurality of key code values and a plurality of letters of an alphabet, said each key code value corresponds to said each letter, said storage unit includes a plurality of data signals and a plurality of voice signals, said each data signal corresponds to said each voice signal, said data signal and voice signal correspond to a word or a phrase, said microprocessor is enabled to perform the following steps while said keyboard enters a word or a phrase for an inquiry:
receiving an input signal including at least one key code value from said keyboard, and searching, according to said input signal, for said key code table to complete the input of a word or a phrase;
initializing said audio processing unit;
enabling said audio processing unit to search for said data signal and voice signal corresponding to said word or said phrase in said storage unit, and displaying said data signal on said screen;
receiving a voice pronunciation signal inputted from said keyboard, and sending said voice pronunciation signal to said audio processing unit; and
enabling said audio processing unit to decode said voice signal according to said voice pronunciation signal and send said decoded voice signal to said voice output section for a playback.

5. The method of claim 4, wherein said voice output section comprises a digital-to-analog converter, an amplifier and a sound player, thereby a procedure is carried out by said microprocessor after said voice signal is decoded, and said procedure comprises the steps of:
enabling said digital-to-analog converter to convert said voice signal into an analog signal;
sending said analog signal to said amplifier for modulating said analog signal according to a gain of said amplifier; and
enabling said sound player to play back said gained analog signal.

6. The method of claim 4, wherein said microprocessor receives a modulate signal inputted from said keyboard for modulating the gain of said amplifier according to said modulate signal.

7. The method of claim 4, wherein said microprocessor processes a procedure for controlling said audio processing unit after receiving said input signal, and said procedure comprises the steps of:
generating a reset signal and sending said reset signal to said audio processing unit for initializing said audio processing unit; and
enabling said audio processing unit to enter into a general operating mode and receive a word or a phrase sent from said microprocessor in said general operating mode, and searching for said corresponding data signal and voice signal in said storage unit.

8. The method of claim 7, wherein said microprocessor processes a procedure after entering into said general operating mode, and said procedure comprises the steps of:
sending an on/off signal to said audio processing unit, when said input signal is not inputted to said electronic device after a wait time; and
enabling said audio processing unit to enter into said off mode.

9. The method of claim 8, wherein said microprocessor processes a procedure after entering into said off mode, and said procedure comprises the steps of:
sending an on/off signal to said audio processing unit, when said input signal is inputted to said electronic device; and
enabling said audio processing unit to enter into said general operating mode.

10. The method of claim 8, wherein said microprocessor continues detecting whether or not said input signal is inputted, when said input signal is not inputted.

11. The method of claim 9, wherein said microprocessor continues detecting whether or not said input signal is inputted, when said input signal is not inputted.

12. The method of claim 4, wherein said microprocessor processes a procedure after searching, according to said input signal, for said key code table, and said procedure comprises the steps of:
sending a start command to said audio processing unit;
sending a word or a phrase to said audio processing unit when said audio processing unit is not executing;
enabling said audio processing unit to search for said data signal and voice signal corresponding to a word or a phrase in said storage unit according to said inputted word or phrase, when said audio processing unit is not executing;
sending said data signal to said screen;
sending said voice pronunciation signal to said audio processing unit; and
enabling said audio processing unit to decode said voice signal and send said decoded voice signal to said voice output section for a playback, when said audio processing unit is not executing.
